(19) United States
(12) Patent Application Publication
(10) Pub. No.: US 2014/0343847 A1
(43) Pub. Date: Nov. 20, 2014

(54) BICYCLE ROUTES WITH ELEVATION

(71) Applicant: Microsoft Corporation, Redmond, WA (US)

(72) Inventor: Brian P. Kernan, Bellevue, WA (US)

(73) Assignee: Microsoft Corporation, Redmond, WA (US)

(21) Appl. No.: 13/893,539

(22) Filed: May 14, 2013

(51) Int. Cl. G01C 21/00

(52) U.S. Cl. CPC G01C 21/00
USPC 701/533; 701/400; 701/540

(57) ABSTRACT

Systems and methods are disclosed for providing route information determined in conjunction with elevation data in response to a route request. More particularly, in response to a route request that identifies an origin and a destination, a set of potential routes are determine and combined with elevation data. Each of the potential routes is scored according to criteria including navigation difficulty. An optimal route is selected and a route presentation is generated and provided to the requesting user in response to the route request.

### BACKGROUND

Many people today rely upon online navigation services to get them from point A (an origin) to point B (a destination). These services are predominantly aimed at automobile drivers, and the suggested route from the navigation service will be that with the shortest predicted travel time. This optimal route is based heavily on shortest distance and maximum use of freeways for longer journeys.

While bicyclists often use the same roads as motorized vehicles in commuting to and from their various destinations, in many instances there are also paths that a bicyclist can use that are not available to motorized vehicles. Moreover, even though there are roads that a bicycle could use, traversing the roads may be difficult to traverse. Addressing this segment of the population, some online navigation services have begun providing cycling-specific navigation information.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods are disclosed for providing route information determined in conjunction with elevation data in response to a route request. More particularly, in response to a route request that identifies an origin and a destination, a set of potential routes are determine and combined with elevation data. Each of the potential routes is scored according to criteria including navigation difficulty. An optimal route is selected and a route presentation is generated and provided to the requesting user in response to the route request.

According to additional aspects of the disclosed subject matter, computer-readable media bearing computer-executable instructions for configuring a computing system to respond to a route request is presented. In response to a route request that identifies an origin and a destination, a set of potential routes are determine and combined with elevation data. Each of the potential routes is scored according to criteria including navigation difficulty. An optimal route is selected and a route presentation is generated and provided to the requesting user in response to the route request.

According further aspects of the disclosed subject matter, a computer system comprising at least a processor and a memory is present for providing route information in response to a route request. In addition to the processor and the memory, the computer system comprises a route generator component configured to generate a set of potential routes from an origin to a destination according to route data in a route data store. The computer system also comprises a route/elevation combination component that combines elevation data to each of the potential routes. A route scoring component that associates a score with each of the potential routes and selects an optimal route according to the associated scores. Still further, a route presentation generator that generates a route presentation based on the selected optimal route, wherein the generated route presentation includes an interactive elevation view indicating the elevation change of the selected optimal route between the origin and destination.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 illustrates a block diagram of an exemplary network environment for implementing aspects of the disclosed subject matter, particularly in regard to providing route information determined in conjunction with elevation data;

FIG. 2 illustrates a flow diagram of an exemplary routine for providing route information determined in conjunction with elevation data;

FIG. 3 illustrates an exemplary information view showing route information generated in conjunction with elevation data;

FIG. 4 illustrates the exemplary information view and further illustrating exemplary aspects of interacting with the route information;

FIG. 5 illustrates a block diagram of exemplary components of a route generation system configure to provide route information determined in conjunction with elevation data; and

FIG. 6 illustrates various components of an exemplary user computer suitably configured to provide route information determined in conjunction with elevation data.

### DETAILED DESCRIPTION

For purposes of clarity, the use of the term “exemplary” in this document should be interpreted as serving as an illustration or example of something, and it should not be interpreted as an ideal and/or a leading illustration of that thing.

While some online navigation services provide routing information for bicyclists, these services continue to provide navigation information as though the bicyclist traveled on a motorized vehicle. In other words, while online navigation services provide route information, the navigation information is provided without regard to the difficulty in traversing the route on a bicycle. Online navigation systems determine their routes in two dimensions, without regard to the difficulty of the route or any segment. For example, while a route that travels up steep hill and then back down to a destination on the far side of the hill may be the shortest, most direct route to the destination, an alternative route that circumnavigates the hill may be easier and faster for a bicyclist to navigate. The disclosed subject matter addresses this failing by combining elevation information into route generation so that a bicyclist may make an informed decision regarding cycling routes.

It should be appreciated that while the following description will be made with regard to bicycling and generating routes for bicyclists, it should be appreciated that this is for illustrative purposes and should not be viewed as limiting upon the disclosed subject matter. Indeed, aspects of the disclosed subject matter, including generating route information with regard to elevation data, may be applied to many aspects of route or navigation generation including generating walking routes for pedestrian use.

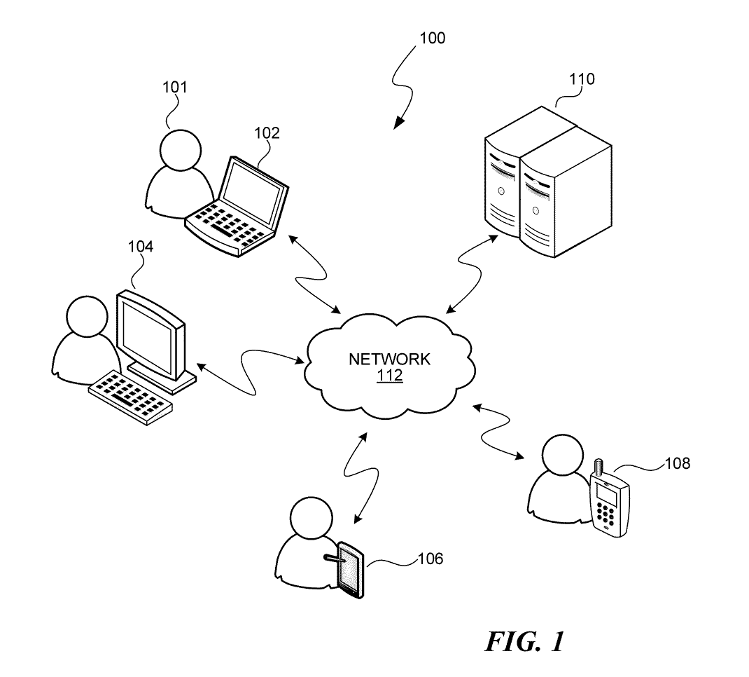

Turning now to FIG. 1, FIG. 1 illustrates a block diagram of an exemplary network environment for implementing aspects of the disclosed subject matter, particularly in regard to providing route information determined in conjunction with elevation data. The exemplary network environment 100 includes one or more user computers, such as user computers 102-108, connected to a network 112, such as the Internet, a wide area network or WAN, and the like. Also connected to the network 112 is a route generator 110 configured to provide route information in response to route queries received from one or more persons/computer users, such as computer user 101 by way of user computer 102 over the network 112.

According to at least one embodiment of the disclosed subject matter, the route generator 110 corresponds to an online service hosted on one or more computers, or computing systems, located and/or distributed throughout the network 112. The route generator 110 receives and responds to route requests submitted over the network 112 from various computer users, such as computer user 101 using user computer 102 over the network 112. As will be described in greater detail below, in response to receiving a route request regarding a bicycle route (or other route for which elevation data may be considered) from a computer user, the route generator 110 identifies one or more routes in conjunction with the elevation data. The route generator 110 determines which of the available routes satisfies the needs of the requesting computer user and returns a route presentation to the computer user. As will be described in more detail below, the route generator 110 may also be configured to respond to modification requests from the computer user in regard to a currently presented route and update the route presentation to the computer user.

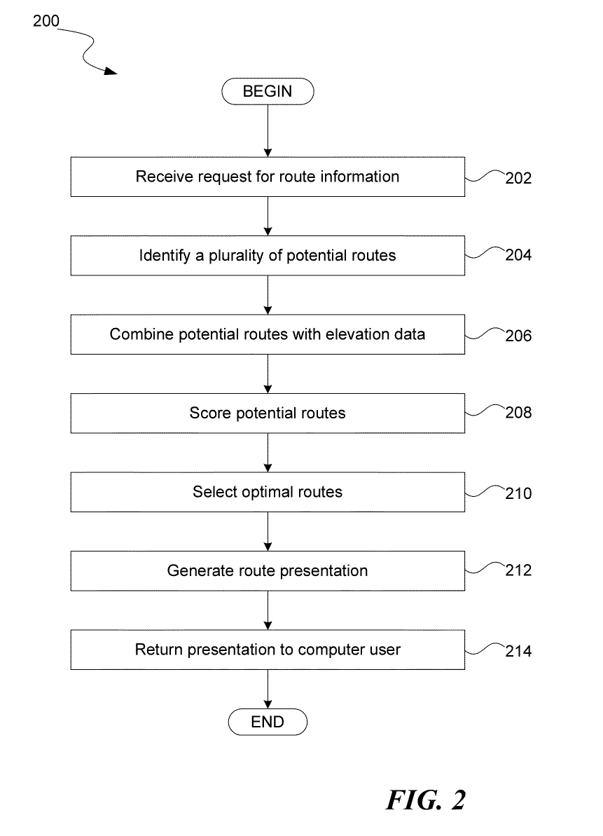

Turning now to FIG. 2, this figure illustrates a flow diagram of an exemplary routine 200 for providing route information determined in conjunction with elevation data. Beginning at block 202, a route request for route information is received. According to various embodiments of the disclosed subject matter, the route request includes an origin and a destination corresponding to the route request. Of course, in an alternative embodiment the exemplary routine may receive a route request without an origin and/or destinations and, as additional steps (not shown) interact with the computer user to obtain the information.

At block 204, one or more potential routes between the origin and destination are identified from a data store of route information. The data store may be local to the computer executing routine 200 or be remotely located such that information from the data store is obtained over the network 112. Identifying routes between an origin and a destination is known in the art, including but not limited to some more well-known techniques such as Dijkstra's algorithm, the B* algorithm, the Bellman-Ford algorithm, and the Floyd-Warshall algorithm. Irrespective the particular selection algorithm that identifies the set of one or more potential routes between the origin and the destination, at block 206 the one or more potential routes are combined with elevation data from a data store. The elevation data may be stored in the same data store with the route information, though alternatively the elevation data may be stored in a separate data store. Additionally, the data store storing the elevation data may be local to the computing system executing routine 200 or may be located remotely such that the information is obtained over the network 112. Combining the one or more potential routes with elevation data comprises associating each of the one or more potential routes with elevation data such that elevation information for a given point in a potential route may be determined. According to various embodiments of the disclosed subject matter, the elevation data may be relative to a reference point (such as the origin or the destination) in the potential route or relative to sea level.

At block 208, the set of one or more potential routes, in combination with the elevation data, are scored according to scoring criteria. Navigation difficult is one of the scoring criteria and, according various embodiments, is the dominant scoring criteria. For example, a first potential route having a lesser navigation difficult would score better (i.e., be more optimal) than a second potential route having a greater navigation difficulty. Other criteria may include, by way of illustration and not limitation, route length and navigation time. Navigation difficulty may be determined according automatically according to elevation changes, steepness of elevation changes, rate of elevation gain/loss, and the like. Alternatively, predetermined navigation difficulty may be associated with route segments. According to various embodiments, ease is determined according to level or gentle slopes. Moreover, while navigation difficult is, by default a dominant scoring criteria, in various embodiments other factors may be configured by the computer user to be dominant, such as navigation time or shortest distance. Moreover, a computer user may indicate a desired level of difficult (i.e., rather than the easiest route the user may prefer a moderately difficult route) such that a potential route with the indicated level of difficulty is more optimal than other potential routes.

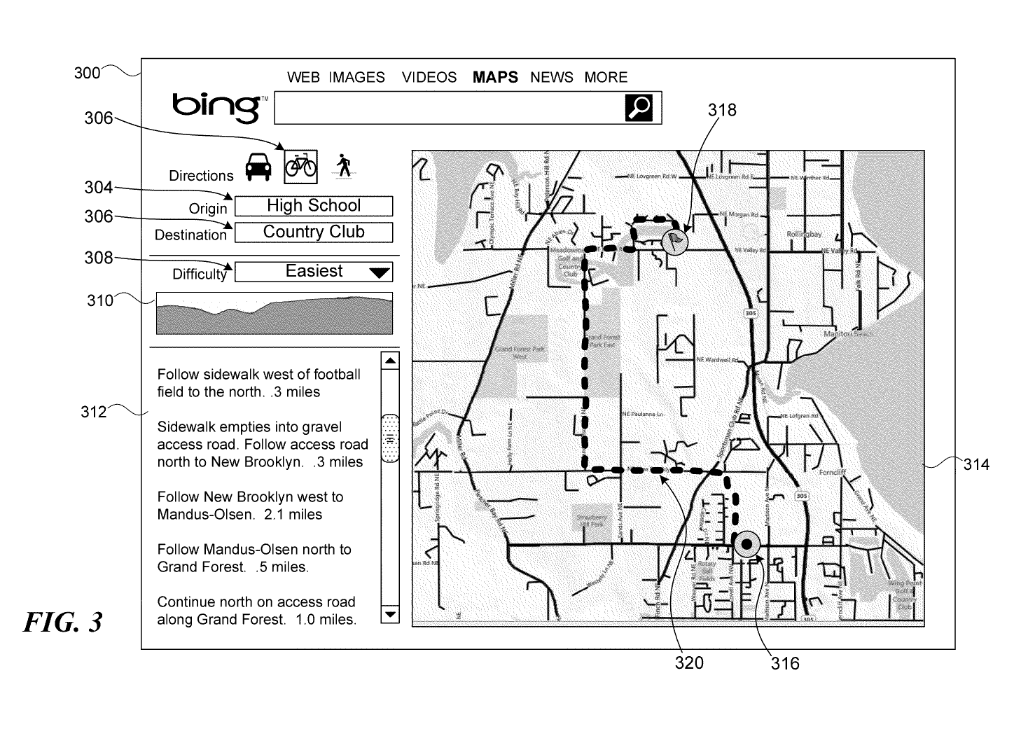

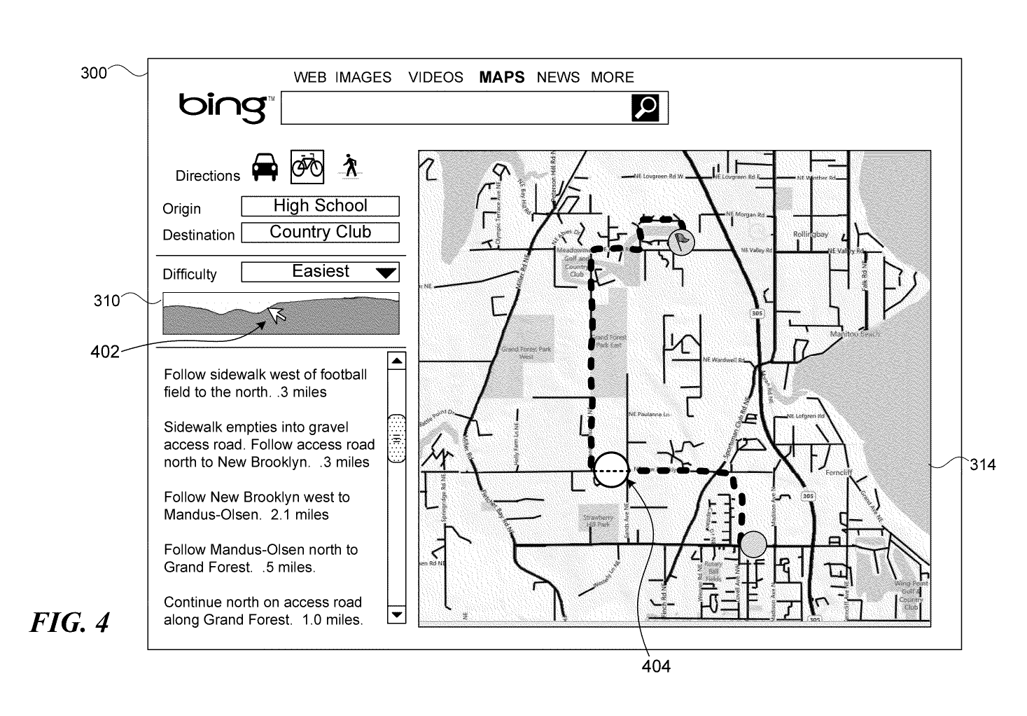

After scoring the set of potential routes, at block 210 an optimal route is selected. This optimal route is the highest scoring route according to the criteria and weighting used in step 208. At block 212 a route presentation is generated for the computer user. FIG. 3 illustrates an exemplary route presentation. More particularly, FIG. 3 illustrates an exemplary route presentation 300 showing route information generated in conjunction with elevation data. As shown in the route presentation 300, the computer user has instructed the route generator 110, by way of selection of cycling icon 306, to provide routing information in consideration of elevation data. The route presentation 300 illustrates an origin by way of text field 304 and a destination by way of text field 306. Instructions 312 for navigation from the origin (the high school) to the destination (the country club) are displayed along with a map view 314. The map view 314 identifies the origin 316 and the destination 318 as well as the generated route 320. Also included in the route presentation is control 308 by which the computer user can specify the difficulty of route that is desired. For example, a computer user may manipulate the control to indicate “moderate” or “challenging.” Of course, the terms “easiest”, “moderate” and “challenging” are just one example of ratings that may be used and should not be viewed as limiting upon the disclosed subject matter. Also shown in the route presentation 300 is an elevation view 310 that indicates the elevation change of the generated route 320 between the origin and destination. According to aspects of the disclosed subject matter, the elevation view 310 may be interactive such that the computer user (i.e., the view of the route presentation) can correlate various locations in the elevation view 310 with a position in the generated route 320 on the map view 314. FIG. 4 illustrates the exemplary route presentation 300 and further illustrates exemplary computer user interaction with the elevation view 310. In particular, upon receiving an indication that a user has interacted with the elevation view 310, such as by placing a cursor 402 at some position within the elevation view 310, a corresponding indicator 404 is positioned on the generated route 320 in the map view 314.

Returning to FIG. 2, block 214 of routine 200 the route presentation is returned to the requesting computer user and the routine 200 terminates.

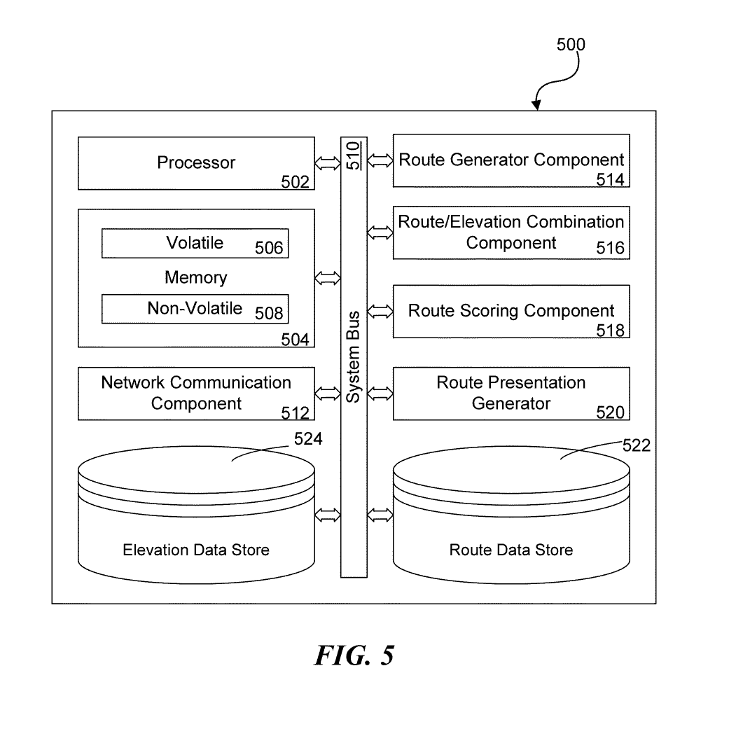

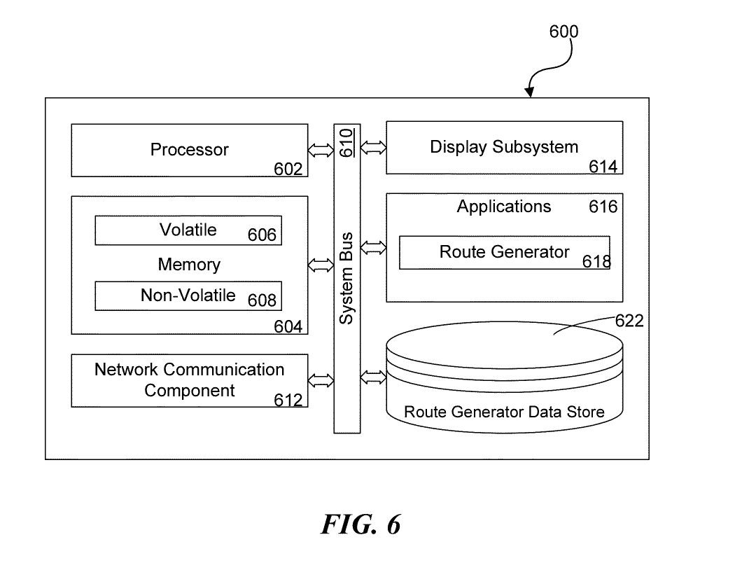

Regarding routine 200, while this routine is expressed in regard to discrete steps, these steps should be viewed as being logical in nature and may or may not correspond to any actual and/or discrete steps of a particular implementation. Nor should the order in which these steps are presented in this routine be construed as the only order in which the steps may be carried out. Moreover, while this routine includes various novel features of the disclosed subject matter, other steps (not listed) may also be carried out in the execution of the routine. Further, those skilled in the art will appreciate that logical steps of this routine may be combined together or be comprised of multiple steps. Steps of routine 200 may be carried out in parallel or in series. Often, but not exclusively, the functionality of the routine is embodied in software (e.g., applications, system services, libraries, and the like) that is executed on computer hardware and/or systems as described below in regard to FIGS. 5 and 6. In various embodiments, all or some of the routine may also be embodied in hardware modules on a computer system.

While many novel aspects of the disclosed subject matter are expressed in routines that are executed as part of, or embodied in applications (also referred to as computer programs), apps (small, generally single or narrow purposed, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When executed on a computing device, the computer-executable instructions stored on one or more computer-readable storage devices carry out various steps, methods and/or functionality, including those steps, described above in regard to routine 200. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

FIG. 5 illustrates a block diagram 500 of exemplary components of a route generation system 500, such as route generator 110, configure to provide route information determined in conjunction with elevation data. The route generation system 500 includes a processor 502 (also referred to as a processing unit) and a memory 504 interconnected by way of a system bus 510. As is readily appreciated by those skilled in the art, the memory 504 typically (but not exclusively) comprises both volatile memory 506 and non-volatile memory 508. Volatile memory 506 retains or stores information so long as the memory is supplied with power. In contrast, non-volatile memory 508 is capable of storing (or persisting) information even when a power supply is not available. Generally speaking, RAM and CPU cache memory are examples of volatile memory whereas ROM and memory cards are examples of non-volatile memory.

The processor 502 executes instructions retrieved from the memory 504 in carrying out various functions, particularly in regard to providing routing information determined in conjunction with elevation data. The processor 502 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; and the like.

The system bus 510 provides an interface for the various components to inter-communicate. The system bus 510 can be of any of several types of bus structures that can interconnect the various components (including both internal and external components). The route generation system 500 also includes a network communication component 512 for interconnecting the vendor site with other computers (including, but not limited to, user computers including user computers 102-108) as well as other devices on a computer network 112. The network communication component 512 may be configured to communicate with an external network, such as network 112, via a wired connection, a wireless connection, or both.

The illustrated route generation system 500 also includes a route generator component 514 that generates a set of routes from an origin to a destination. According to one embodiment of the disclosed subject matter, the route generation system 500 obtains route data from a route data store 522 that the route generation system maintains. Of course, in an alternative embodiment, the route generation system 500 may obtain route data from one or more external sources over the network 112. In yet a further alternative embodiment, the route generation system 500 may obtain route data from both a local route data store 522 and from one or more external sources over the network 112. As discussed above, the route generation system 500 may generate routes from the route data according to any number of techniques and algorithms, including Dijkstra's algorithm, the B* algorithm, the Bellman-Ford algorithm, the Floyd-Warshall algorithm, and the like.

A route/elevation combination component combines elevation data with the set of potential routes between the origin and the destination. According to various embodiments, the elevation data is maintained by the route generation system 500 in an elevation data store 524. Of course, in alternative embodiments, the route generation system 500 may obtain elevation data from one or more external sources over the network 112. In yet further alternative embodiments, the route generation system 500 may obtain elevation data from both a local elevation data store 524 and from one or more external sources over the network 112.

The route scoring component 518 associates a score with each of the potential routes (combined with elevation data) to determine a best route for the requesting computer user. The route scoring component 518 determines a score according to factors that include difficulty in navigating a potential route on a bicycle, the length of the potential route, the estimated time to navigate the potential route, the type of path segments that are included in the potential route, and the like. These factors also take into consideration any user input, such as whether the requesting computer user has indicated that he/she would like the easiest route to navigate, a moderately difficult route, a shortest time route, and the like. The potential route that best satisfies the various factors is selected as the optimal route and the route presentation generator 520 generates a route presentation for the requesting computer user. As discussed above, the generated route presentation is then provided to the requesting computer user over the network 112 by way of the network communication component 512.

While aspects of the disclosed subject matter may be implemented on a route generation system 500 as described above, where a computer user submits a route request to the route generation system and receives a route presentation in response to the query, aspects of the disclosed subject matter be also be implemented on a user computer. FIG. 6 illustrates various components of an exemplary user computer 600 suitably configured to provide route information determined in conjunction with elevation data.

As shown in FIG. 6, the exemplary user computer 600 includes a processor 602 and a memory 604 interconnected by way of a system bus 610. As discussed above, the memory 604 typically (but not exclusively) comprises both volatile memory 606 and non-volatile memory 608. Volatile memory 606 retains or stores information so long as the memory is supplied with power. In contrast, non-volatile memory 608 is capable of storing (or persisting) information even when a power supply is not available. Generally speaking, RAM and CPU cache memory are examples of volatile memory whereas ROM and memory cards are examples of non-volatile memory.

The processor 602 executes instructions retrieved from the memory 604 in carrying out various functions, particularly in regard to providing routing information determined in conjunction with elevation data. The processor 602 may be comprised of any of various commercially available processors such as single-processor, multi-processor, single-core units, and multi-core units. Also included in the exemplary user computer 600 are one or more applications 616 that include a route generator application 618 configured to generate route information determined in conjunction with elevation data for the computer user. According to various embodiments, the route generator application 618 includes components similar to those described above in regard to FIG. 5 including, by way of illustration and not limitation, the route generator component 514, the route/elevation combination component 516, the route scoring component 518, and the route presentation generator 520. According to various embodiments, the route generator application 618 obtains route and elevation information from a route generator data store 622. Alternatively, the route generator application 618 may be configure to obtain all or some of the route and/or elevation information from external sources including sources over the network 112 by way of the network communication component 612.

Those skilled in the art will appreciate that the various components of FIGS. 5 and 6 described above may be implemented as executable software modules within the computer systems, implemented as hardware modules (including SoCs—system on a chip), or implemented a combination of the two. Moreover, each of the various components may be implemented as an independent, cooperative process or device, operating in conjunction with one or more computer systems. It should be further appreciated, of course, that the various components described above in regard to the route generation components discussed above in regard to FIGS. 5 and 6 should be viewed as logical components for carrying out the various described functions. As those skilled in the art appreciate, logical components (or subsystems) may or may not correspond directly, in a one-to-one manner, to actual, discrete components. In an actual embodiment, the various components of each computer system may be combined together or broke up across multiple actual components and/or implemented as cooperative processes on a computer network 112.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for bicycling route information in response to a bicycling route request from a computer user, the route request identifying an origin and a destination, the method comprising:
obtaining a set of potential routes between the origin and the destination;
combining each of the potential routes with elevation data;
scoring each of the potential routes and selecting an optimal route according to the scores of the potential routes;
generating a route presentation based on the optimal route; and
providing the route presentation to the computer user.

2. The computer-implemented method of claim 1, wherein generating the route presentation comprises including an elevation view in the route presentation, the elevation view indicating the elevation change of the selected optimal route between the origin and destination.

3. The computer-implemented method of claim 2 further comprising receiving an indication of a selection of a position of the elevation view and placing an indicator on a route map included in the generated route presentation, wherein the indicator is located on the selected optimal route at the location corresponding to selected position in the elevation view.

4. The computer-implemented method of claim 1, wherein scoring each of the potential routes comprises scoring each of the potential routes according to navigation difficulty of a potential route.

5. The computer-implemented method of claim 4, wherein a first potential route with a lesser navigation difficulty is more optimal than a second potential route with a greater navigation difficulty.

6. The computer-implemented method of claim 4, wherein the route request includes an indicated level of difficulty, and where a first potential route with the specified navigation difficulty is more optimal than a second potential route with a different navigation difficulty.

7. The computer-implemented method of claim 1, wherein obtaining a set of potential routes between the origin and the destination comprises obtaining a set of potential routes between the origin and the destination from an external source.

8. The computer-implemented method of claim 1, wherein obtaining a set of potential routes between the origin and the destination comprises determining a set of potential routes between the origin and the destination from a local route data store.

9. The computer-implemented method of claim 8, wherein the set of potential routes between the origin and the destination are obtained from the local route data store according to a Dijkstra algorithm.

10. The computer-implemented method of claim 8, wherein the set of potential routes between the origin and the destination are obtained from the local route data store according to a B* algorithm.

11. A computer-readable medium bearing computer-executable instructions which, when executed on a computing system comprising at least a processor executing instructions retrieved from the medium, carry out a method for responding to a bicycling route request identifying an origin and a destination from a computer user, the method comprising:
obtaining a set of potential routes between the origin and the destination;
combining each of the potential routes with elevation data;
scoring each of the potential routes and selecting an optimal route according to the scores of the potential routes;
generating a route presentation based on the optimal route, wherein the route presentation comprises an interactive elevation view indicating the elevation change of the selected optimal route between the origin and destination; and
providing the route presentation to the computer user.

12. The computer-readable medium of claim 11, wherein the method further comprises receiving an indication of a selection of a position of the interactive elevation view and placing an indicator on a route map included in the generated route presentation, wherein the indicator is located on the selected optimal route at the location corresponding to selected position in the elevation view.

13. The computer-readable medium of claim 12, wherein scoring each of the potential routes comprises scoring each of the potential routes according to the navigation difficulty of a potential route.

14. The computer-readable medium of claim 13, wherein a first potential route with a lesser navigation difficulty is more optimal than a second potential route with a greater navigation difficulty.

15. The computer-readable medium of claim 13, wherein the route request includes an indicated level of difficulty, and where a first potential route with the specified navigation difficulty is more optimal than a second potential route with a different navigation difficulty.

16. The computer-readable medium of claim 12, wherein obtaining a set of potential routes between the origin and the destination comprises determining a set of potential routes between the origin and the destination from a local route data store.

17. The computer-readable medium of claim 16, wherein the set of potential routes between the origin and the destination are obtained from the local route data store according to a Dijkstra algorithm or a B* algorithm.

18. A computer system for providing route information in response to a route request, the system comprising a processor and a memory, wherein the processor executes instructions stored in the memory as part of or in conjunction with additional components to respond to a route request, the additional components comprising:
a route generator component that generates a set of potential routes from an origin to a destination according to route data in a route data store;
a route/elevation combination component that combines elevation data to each of the of potential routes;
a route scoring component that associates a score with each of the potential routes and selects an optimal route according to the associated scores; and
a route presentation generator that generates a route presentation based on the selected optimal route, wherein the generated route presentation includes an interactive elevation view indicating the elevation change of the selected optimal route between the origin and destination.

19. The computer system of claim 18, wherein route scoring component determines a score associated with each of the potential routes according to the navigation difficulty of a potential route.

20. The computer system of claim 18, wherein the route request includes an indicated level of difficulty, and where the route scoring component scores a first potential route with the specified navigation difficulty as more optimal than a second potential route with a different navigation difficulty.
